(19) United States
(12) Patent Application Publication
(10) Pub. No.: US 2011/0307452 A1
(43) Pub. Date: Dec. 15, 2011

(54) PERFORMING CODE ANALYSIS IN A MULTI-TENANT DATABASE SYSTEM

(75) Inventors: Robert Fly, Moraga, CA (US); Collin Greene, San Francisco, CA (US); Brendan O'Connor, San Francisco, CA (US); Brian Soby, Emeryville, CA (US)

(73) Assignee: Salesforce.com, inc., San Francisco, CA (US)

(21) Appl. No.: 12/977,593

(22) Filed: Dec. 23, 2010

Related U.S. Application Data
(60) Provisional application No. 61/354,150, filed on Jun. 11, 2010.

(51) Int. Cl. G06F 17/30

(52) U.S. Cl. 707/687; 707/E17.005

(57) ABSTRACT

A system and method for performing code analysis in a database system. In one embodiment, a method includes receiving a request to scan code for a software application. The method further includes fetching metadata associated with a user, fetching the code for the software application, and scanning the code.

### CLAIM OF PRIORITY

This application claims the benefit of U.S. Provisional Patent Application 61/354,150 entitled, “Methods and Systems for Performing Source Code Analysis in a Multi-Tenant Database System,” filed Jun. 11, 2010 (Attorney Docket No. SALEP0008P), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to performing code analysis in a database network system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which, in and of themselves, may also be inventions.

In conventional database systems, users access their data resources in one logical database. A user of such a conventional system typically retrieves data from and stores data on the system using the user's own systems. A user system might remotely access one of a plurality of server systems that might in turn access the database system. To perform these and other functions, users may write code for the database system. Unfortunately, the code could have security issues.

### BRIEF SUMMARY

Embodiments provide mechanisms and methods for performing code analysis in a database system. In one embodiment, a method includes receiving a request to scan code for a software application. The method further includes fetching metadata associated with a user, fetching the code for the software application, and scanning the code.

While one or more implementations and techniques are described, one or more embodiments may be implemented in a system having an application server providing a front end for an on-demand database service capable of supporting multiple tenants. The embodiments described herein are not limited to multi-tenant databases or deployment on application servers. Embodiments may be practiced using other database architectures, i.e., ORACLE®, DB2® by IBM, database file system, and the like, without departing from the scope of the embodiments claimed.

Any of the above embodiments may be used alone or together with one another in any combination. Embodiments described herein may also include embodiments that are only partially mentioned or alluded to, or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the embodiments described are not limited to the examples depicted in the figures.

FIG. 1 illustrates a block diagram of an example environment, which may be used to implement the embodiments described herein.

FIG. 2 illustrates an example simplified flow diagram for performing code analysis in a database system, according to one embodiment.

FIG. 3 illustrates a block diagram of an example environment where a database service might be used, and which may be used to implement the embodiments described herein.

FIG. 4 illustrates a block diagram of another example environment, which may be used to implement the embodiments described herein.

### DETAILED DESCRIPTION

### General Overview

Systems and methods are provided for performing code analysis in a database system.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for performing code analysis in a database system will be described with reference to example embodiments.

### System Overview

Embodiments described herein enable, facilitate, and manage code analysis in a database environment such as an on-demand database services system. In one embodiment, a user may initiate a scan on code for a software application. After receiving the request, the system fetches metadata associated with the user, and fetches the code. The system then scans the code to identify security issues such as security vulnerabilities, malicious code, etc. The system may also scan the code to ensure quality. These scans may be performed on demand or periodically. In one embodiment, the code may be scanned at the time of it being published and/or saved as well, giving users real-time feedback on the code's security and quality.

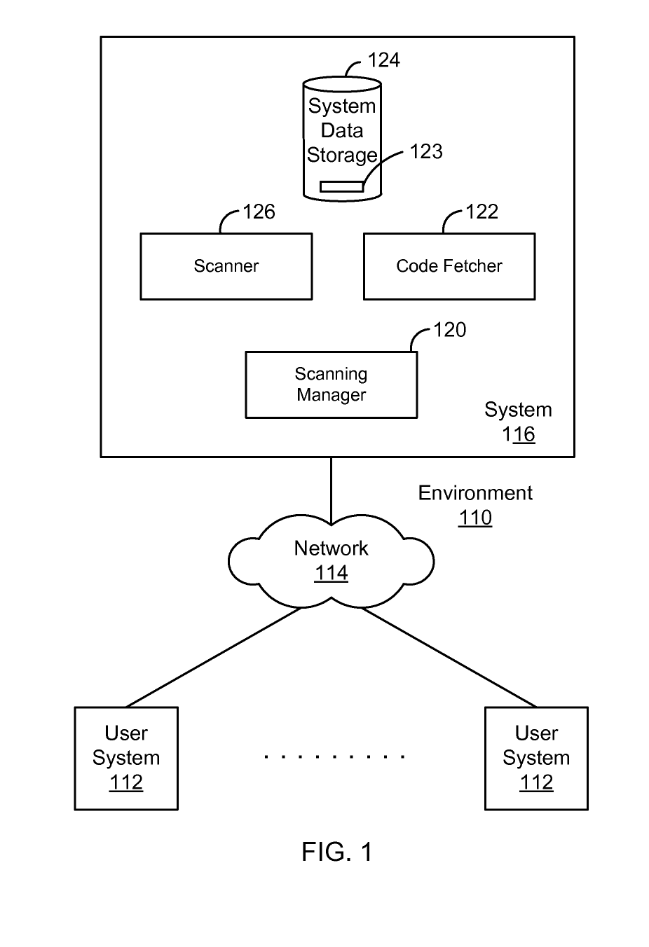

FIG. 1 illustrates a block diagram of an example environment 110, which may be used to implement the embodiments described herein. In one embodiment, environment 110 includes one or more user systems 112, a network 114, and a system 116. System 116 may be an on-demand database system such as a multi-tenant database system or cloud service provider, which provides resources to partners and/or to end-customers as a service. In one embodiment, system 116 includes a scanning manager 120, code fetcher 122 for fetching code 123 for a software application to be scanned, system data storage 124, and a scanner 126.

In other embodiments, environment 110 may not have all of the components listed and/or may have other elements instead of, or in addition to, those listed above. The component blocks of system 116 shown in FIG. 1 may be implemented by one or more processors or any combination of hardware devices, as well as any combination of hardware, software, firmware, etc.

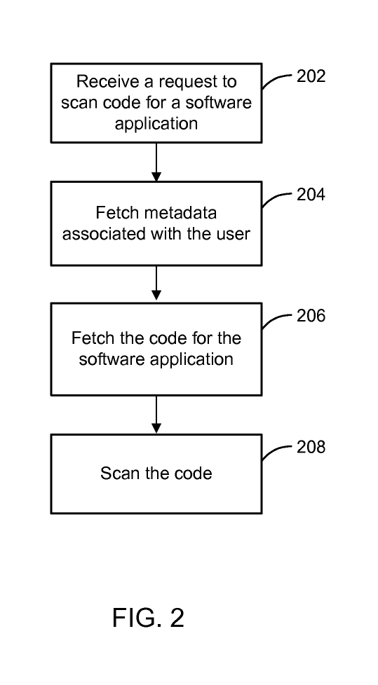

FIG. 2 illustrates an example simplified flow diagram for performing code analysis in a database system, according to one embodiment. Referring to both FIGS. 1 and 2, the method is initiated in block 202, where system 116 receives a request to scan code for a software application. In one embodiment, scanning manager 120 of system 116 receives the request from a user. In one embodiment, the user may provide the request via a self-service portal (e.g., user system 112). The user may also provide information about the user (e.g., name identification, organization identification, etc.) and information about the code (e.g., code identification, etc.).

As described in more detail below, scanning manager 120 manages the scanning process by managing the components of system 116 (e.g., code fetcher 122, scanner 126, etc.) that perform aspects of the scanning process. In one embodiment, the receipt of the scan request initiates the scan. In one embodiment, the user may be a partner, developer of the software application, end-customer, or an internal user (e.g., administrator or manager of system 116). In one embodiment, the code may be for software applications that the user submits to be integrated with system 116. For example, the code may be for a software application developed by a partner and provided to the partner's end-customers via system 116.

In one embodiment, system 116 may require a user to initiate a scan for newly submitted code or for new versions of code that is submitted, and before the code may be published for general use (e.g., used by end-customers, etc.).

In one embodiment, the code analysis may be performed on an ad-hoc basis. For example, in one embodiment, a given user may initiate a scan when desired, on an ad-hoc basis.

In one embodiment, scanning on an ad-hoc basis may require a particular portal (e.g., via a Force.com site) that allows users to submit information about their organization in order to begin a scan. In one embodiment, a user may submit at least a username (e.g., user identification) to begin the scan process. In one embodiment, system 116 enables users to scan code directly when saving the code, giving users read-time feedback on the security and quality of the code.

In one embodiment, the code analysis may be performed periodically. For example, in one embodiment, a code may be scanned periodically and initiated automatically by system 116. In this embodiment, system 116 would not need to receive a scan request from a user. Instead, system 116 may automatically generate a request or command to initiate the scan process. In one embodiment, these periodic scans may be a part of an internal review process (e.g., for AppExchange reviews). In one embodiment, these periodic scans may be performed at predefined time periods (e.g., every week, every month, every 3 months, etc.).

In one embodiment, the user may select scanning rules for scanning the code. Such rules may range from superficial to comprehensive rules for scanning. Also, in one embodiment, the user may select a level of quality for the code.

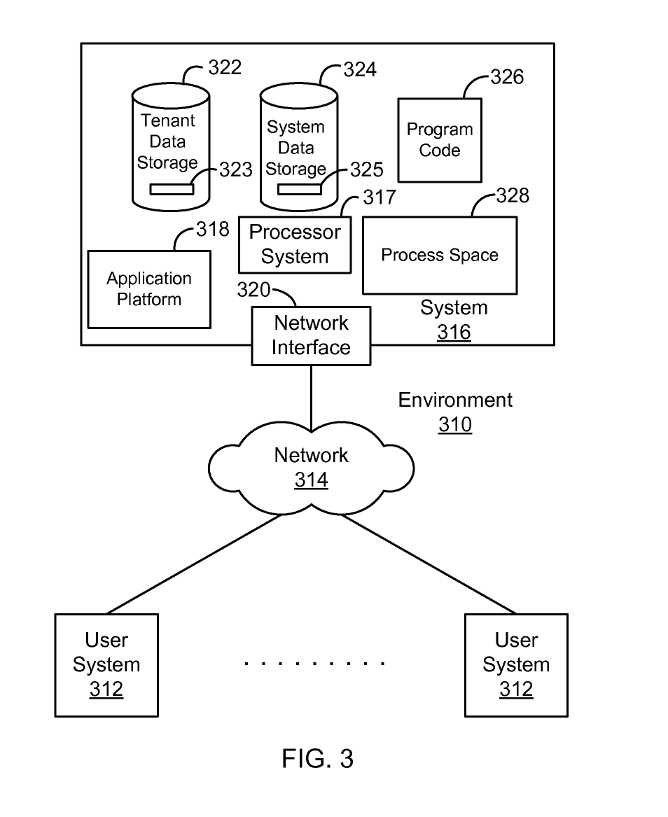

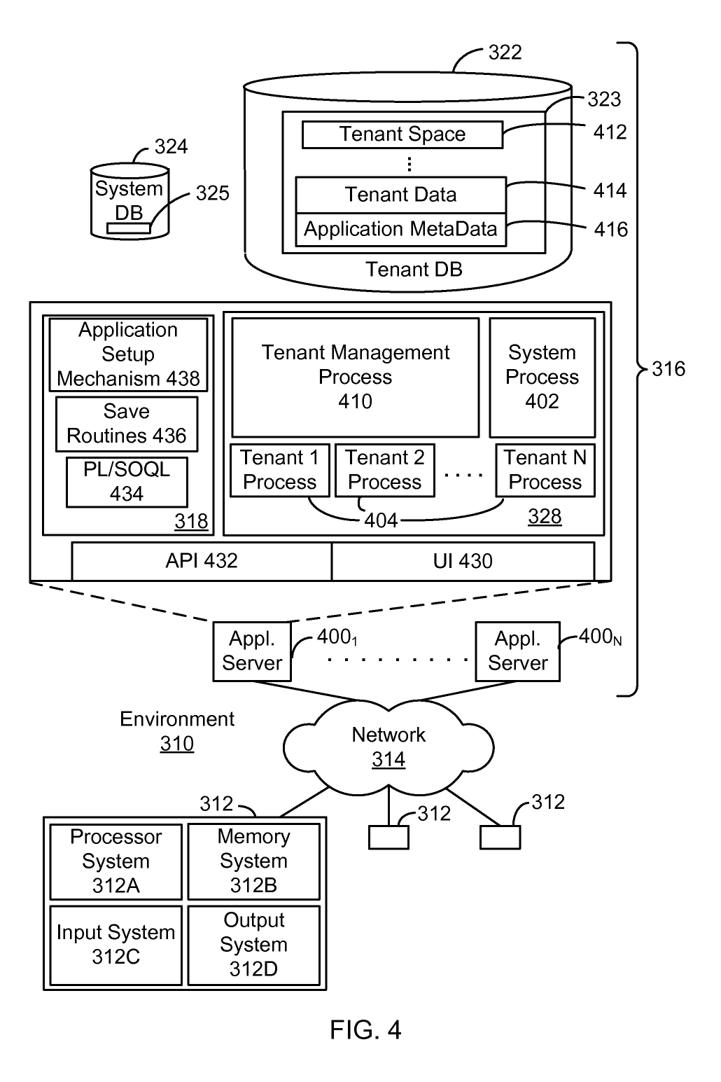

While system 116 is described as performing the steps as described in the embodiments herein, any suitable component or combination of components of system 116 or any suitable processor or processors associated with system 116 may perform the steps described. For example, the steps may be performed by processor system 317 or process space 328 of FIG. 3, by system process 402 of FIG. 4, or by any other suitable processor or processors associated with system 116.

In block 204, system 116 fetches metadata associated with the user. In one embodiment, scanning manager 120 fetches the metadata, which may be stored in system data storage (e.g., system data storage 124 of FIG. 1, or system data storage 324 of FIGS. 3 and 4). In one embodiment, the metadata includes information about the user. For example, the metadata may identify who the user is and other information about the user (e.g., name, permissions, administrative capabilities such as permissions to request a scan, associated organization, etc.), information about the user's organization, information about previously submitted code and associated scan results, code packages associated with that user, and/or the instance or repository where the code is stored. In one embodiment, the metadata may be used for running and reporting on the scan. Note that system 116 fetches metadata about the user, but not customer data (e.g., data in tenant data storage).

In block 206, system 116 fetches the code 123 for the software application to be scanned. In one embodiment, system 116 initiates code fetcher 122 in order to fetch or pull the code. In one embodiment, the code may be stored in system data storage (e.g., system data storage 425 of FIGS. 4 and 5). A copy of the code may remain in the system data storage for future scans. The terms “code,” “source code,” and “software application” may be used interchangeably.

In one embodiment, the pulled code is the entire code for the software application. In one embodiment, the pulled code is a portion of the entire code for the software application. In one embodiment, system 116 may fetch the code that was developed by the requesting user (or the user's organization), but would not fetch third-party code that was not developed by the requesting user (or the user's organization). In one embodiment, system 116 may require user identification in order to obtain organization identification for pulling the code.

In one embodiment, the code is stored in the system data storage after the user submits the code for scanning. In one embodiment, the code is not executed or provided for general use until after it passes the scan, and passes any other required security checks and approval processes. In one embodiment, after system 116 fetches the code, system 116 may send the code to an intermediary storage location within system 116, which scanner 126 may later retrieve for scanning. In one embodiment, system 116 may also send the code directly to scanner 126 for scanning. In one embodiment, system 116 packages the code with its associated metadata.

In one embodiment, after the code is successfully fetched, scanning manager 120 may provide scanner 126 with a pointer to the code. In one embodiment, if the code is larger than a predefined size (e.g., 2 mb), system 116 may put the code at the back of the queue, or, alternatively, put the code at the back of the queue until a predefined time (e.g., after hours).

In block 208, system 116 scans code 123. In one embodiment, system 116 initiates scanner 126 in order to scan the code. In one embodiment, scanner 126 may be integral to system 116. In one embodiment, scanner 126 may be a stand-alone scanner. In one embodiment, scanner 126 may be a third-party scanner. Furthermore, scanner 126 may be any security tool (e.g., code scanner, runtime analysis, etc.).

In one embodiment, if the code is running on a new object (e.g., new custom object), system 116 determines as much information about the object as possible. For example, system 116 may determine the types of fields the object contains. If the object contains all numeric fields, the objection would be safer from certain types of vulnerabilities than if the object contains some text fields.

In one embodiment, scanner 126 runs the regular static analysis processes for each piece of code to identify security issues. Scanner 126 may apply scanning rules (e.g., rules associated with hard coded passwords, escape false warnings, password misuse, URL redirection attacks, and HTTP callouts to detect if a native software application is trying to call something remotely, etc.).

In one embodiment, system 116 also scans the code to ensure that the code has a certain minimum level of quality (e.g., hardcoded URL/ID references, queries without limits, etc.). For example, if the code to be uploaded is to be sold to end-customers, scanner 126 may analyze the functionality of the code to ensure it could run properly. In one embodiment, scanner 126 may determine if the code meets particular design requirements.

In block 210, system 116 generates a report based on the results of the scan. In one embodiment, scanning manager 120 generates the report, and then sends out the report to appropriate recipients. In one embodiment, the report may identify any security issues, such as security vulnerabilities and malicious code found in the code during the scan. In one embodiment, the report may also identify quality issues.

In one embodiment, scanning manager 120 may poll scanner 126 periodically (e.g., every minute) to determine if any of its scans are completed. Any delays may be reported to the user who requested the scan. Upon completion of a scan, scanning manager 120 generates the report. Scanning manager 120 the saves the report information in a suitable location such as a system data storage.

In one embodiment, system 116 sends the report to appropriate recipients. For example, recipients may include any predefined user (e.g., developer, user who requested the scan, administrator, manager, etc.) of system 116. In one embodiment, after scanning, system 116 deletes the code. Any users that receive the report may address identified security and quality issues accordingly.

Embodiments described herein provide numerous benefits. For example, embodiments inherently protect against many security issues and unintentional vulnerabilities that may be introduced into partners' code, customers' code, and code internal to the platform. Embodiments ensure security and quality, even as the platform is opened up to more functionality and new software applications introduced by partners such as AppExchange partners. Embodiments benefit partners by enabling partners and end-customers by ensuring software applications of higher quality and security. These embodiments provide scanning of software applications in an on-demand platform as a service offering.

FIG. 3 illustrates a block diagram of an example environment 310 where a database service might be used, and which may be used to implement the embodiments described herein. Environment 310 may include user systems 312, network 314, system 316, processor system 317, application platform 318, network interface 320, tenant data storage 322, system data storage 324, program code 326, and process space 328. In other embodiments, environment 310 may not have all of the components listed and/or may have other elements instead of, or in addition to, those listed above.

Environment 310 is an environment in which an on-demand database service exists. User system 312 may be any machine or system that is used by a user to access a database user system. For example, any of user systems 312 can be a handheld computing device, a mobile phone, a laptop computer, a work station, and/or a network of computing devices. As illustrated in FIG. 3 (and in more detail in FIG. 4) user systems 312 might interact via a network 314 with an on-demand database service, which is system 316. System 316 may also be referred to as a cloud service provider. System 316 provides its resources to customers (e.g., end users) as a service.

An on-demand database service, such as system 316, is a database system that is made available to outside users who do not need to necessarily be concerned with building and/or maintaining the database system, but instead may be available for more general use when the users need the database system (e.g., on the demand of the users). Some on-demand database services may store information from one or more tenants stored into tables of a common database image to form a multi-tenant database system (MTS). Accordingly, “on-demand database service 316” and “system 316” will be used interchangeably herein. A database image may include one or more database objects. A relational database management system (RDMS) or the equivalent may execute storage and retrieval of information against the database object(s). Application platform 318 may be a framework that allows the applications of system 316 to run, such as the hardware and/or software, e.g., the operating system. In an embodiment, system 316 may include an application platform 318 that enables creating, managing, and executing one or more applications developed for an on-demand database service, for users accessing the on-demand database service via user systems 312, or for third party application developers accessing the on-demand database service via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global internetwork of networks often referred to as the “Internet” with a capital “I.” That network will be used in many of the examples herein. However, it should be understood that the networks used with the embodiment described herein use are not so limited, although TCP/IP is a frequently implemented protocol.

User systems 312 might communicate with system 316 using TCP/IP and, at a higher network level, use other common Internet protocols to communicate, such as hypertext transfer protocol (HTTP), file transfer protocol (FTP), Andrew file system (AFS), wireless application protocol (WAP), etc. In an example where HTTP is used, user system 312 might include an HTTP client commonly referred to as a “browser” for sending and receiving HTTP messages to and from an HTTP server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as to provide related data, code, forms, webpages and other information to and from user systems 312. The application servers are also configured to store to, and retrieve from, a database system related data, objects, and Webpage content. With a multi-tenant system, data for multiple tenants may be stored in the same physical database object. Tenant data may be arranged such that data of one tenant is kept logically separate from that of other tenants so that one tenant does not have access to another tenant's data, unless such data is expressly shared. In certain embodiments, system 316 implements applications other than, or in addition to, a CRM application. For example, system 316 may provide tenant access to multiple hosted (standard and custom) applications, including a CRM application. User (or third party application developer) software applications, which may or may not include CRM, may be supported by the application platform 318, which manages the creation and storage of the applications into one or more database objects, and executing of the applications in a virtual machine in the process space of the system 316. The terms “application,” “software application,” “software package,” “software code,” and “program code” are used interchangeably.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MTS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 312 to access, process and view information, pages and applications available to it from system 316 over network 314. Each user system 312 also typically includes one or more user interface devices, such as a keyboard, a mouse, trackball, touch pad, touch screen, pen or the like, for interacting with a graphical user interface (GUI) provided by the browser on a display (e.g., a monitor screen, liquid crystal display (LCD) monitor, etc.) in conjunction with pages, forms, applications and other information provided by system 316 or other systems or servers. For example, the user interface device can be used to access data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Pentium® processor or the like. Similarly, system 316 (and additional instances of an MTS, where more than one is present) and all of their components might be operator configurable using application(s) including computer code to run using a central processing unit such as processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a read-only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., object oriented database management system (OODBMS) or rational database management system (RDBMS)) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 illustrates a block diagram of another example environment 310, which may be used to implement the embodiments described herein. FIG. 4 also illustrates elements of system 316 and various interconnections, according to one embodiment. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, user interface (UI) 430, application program interface (API) 432, PL/Salesforce.com object query language (PL/SOQL) 434, save routines 436, application setup mechanism 438, applications servers 400₁-400_{N}, system process space 402, tenant process spaces 404, tenant management process space 410, tenant storage area 412 (labeled “Tenant Space 412” in FIG. 4), user storage 414 (labeled “Tenant Data 414” in FIG. 4), and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3. Regarding user system 312, processor system 312A may be any combination of one or more processors. Memory system 312B may be any combination of one or more memory devices, short term, and/or long term memory. Input system 312C may be any combination of input devices, such as one or more keyboards, mice, trackballs, scanners, cameras, and/or interfaces to networks. Output system 312D may be any combination of output devices, such as one or more monitors, printers, and/or interfaces to networks. As shown in FIG. 3, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage areas 412, which can be either a physical arrangement and/or a logical arrangement of data. Within each tenant storage area 412, user storage 414 and application metadata 416 might be similarly allocated for each user. For example, a copy of a user's most recently used (MRU) items might be stored to user storage 414. Similarly, a copy of MRU items for an entire organization that is a tenant might be stored to tenant storage area 412. A UI 430 provides a user interface and an API 432 provides an application programmer interface to system 316 resident processes and to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410, for example. Invocations to such applications may be coded using PL/SOQL 434 that provides a programming language style interface extension to API 432. Invocations to applications may be detected by one or more system processes, which manage retrieving application metadata 416 for the subscriber, making the invocation and executing the metadata as an application in a virtual machine.

Each application server 400 may be communicably coupled to database systems, e.g., having access to system data 325 and tenant data 323, via a different network connection. For example, one application server 400₁ might be coupled via the network 314 (e.g., the Internet), another application server 400_{N-1} might be coupled via a direct network link, and another application server 400_{N} might be coupled by yet a different network connection. Transfer control protocol and Internet protocol (TCP/IP) are typical protocols for communicating between application servers 400 and the database system. However, it will be apparent to one skilled in the art that other transport protocols may be used to optimize the system depending on the network connection used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles the storage of, and access to, different objects, data and applications across disparate users and organizations.

As an example of storage, one tenant might be a company that employs a sales force where each salesperson uses system 316 to manage his or her sales process. Thus, a user might maintain contact data, leads data, customer follow-up data, performance data, goals and progress data, etc., all applicable to that user's personal sales process (e.g., in tenant data storage 322). In an example of an MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

In certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more structured query language (SQL) statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the embodiments described herein. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium (also referred to as a machine-readable storage medium) for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While one or more implementations have been described by way of example and in terms of the specific embodiments, it is to be understood that the implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for performing code analysis in a database system, the method comprising:
receiving a request to scan code for a software application;
fetching metadata associated with a user;
fetching the code for the software application; and
scanning the code.

2. The method of claim 1, further comprising generating a report based on results of the scanning.

3. The method of claim 1, further comprising generating a report based on results of the scanning, wherein the report identifies security issues.

4. The method of claim 1, further comprising generating a report based on results of the scanning, wherein the report identifies quality issues.

5. The method of claim 1, wherein the code analysis is performed on an ad-hoc basis.

6. The method of claim 1, wherein the code analysis is performed periodically.

7. The method of claim 1, wherein if the code is running on a new object, further comprising determining types of fields the new object contains.

8. A computer-readable storage medium carrying one or more sequences of instructions thereon for performing code analysis in a database system, the instructions when executed by a processor cause the processor to:
receive a request to scan code for a software application;
fetch metadata associated with a user;
fetch the code for the software application; and
scan the code.

9. The computer-readable storage medium of claim 8, wherein the instructions further cause the processor to generate a report based on results of the scanning.

10. The computer-readable storage medium of claim 8, wherein the instructions further cause the processor to generate a report based on results of the scanning, wherein the report identifies security issues.

11. The computer-readable storage medium of claim 8, wherein the instructions further cause the processor to generate a report based on results of the scanning, wherein the report identifies quality issues.

12. The computer-readable storage medium of claim 8, wherein the code analysis is performed on an ad-hoc basis.

13. The computer-readable storage medium of claim 8, wherein the code analysis is performed periodically.

14. The computer-readable storage medium of claim 8, wherein, if the code is running on a new object, the instructions further cause the processor determine types of fields the new object contains.

15. An apparatus for performing code analysis in a database system, the apparatus comprising:
a processor; and
a storage device storing one or more stored sequences of instructions which when executed by the processor cause the processor to:
receive a request to scan code for a software application;
fetch metadata associated with a user;
fetch the code for the software application; and
scan the code.

16. The apparatus of claim 15, wherein the instructions further cause the processor to generate a report based on results of the scanning.

17. The apparatus of claim 15, wherein the instructions further cause the processor to generate a report based on results of the scanning, wherein the report identifies security issues.

18. The apparatus of claim 15, wherein the instructions further cause the processor to generate a report based on results of the scanning, wherein the report identifies quality issues.

19. The apparatus of claim 15, wherein the code analysis is performed on an ad-hoc basis.

20. The apparatus of claim 15, wherein the code analysis is performed periodically.
